(19) United States
(12) Patent Application Publication
(10) Pub. No.: US 2002/0123927 A1
(43) Pub. Date: Sep. 5, 2002

(54) Profit sharing method

(75) Inventor: Yoshihiko Obata, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/919,843

(22) Filed: Aug. 2, 2001

(30) Foreign Application Priority Data
Mar. 2, 2001 (JP) 2001-057986

(51) Int. Cl. G06F 17/60

(52) U.S. Cl. 705/14

(57) ABSTRACT

A questionnaire is created based on a questionnaire table, which contains elements characterizing a commercial article and options prepared for each element. A participant answers questionnaires, the answers are collected, and an option selected by a maximum number of participants is specified as an adopted option for every element. Then, an image of the article characterized by the adopted options is formed. Some portion of a profit acquired by selling the article is shared among the participants. The portion for the participant is determined with respect to a degree of contribution to the development.

### BACKGROUND OF THE INVENTION

1. Field of the Invention

The present invention relates to a commercial article developing method of prompting consumers to participate in developing the article, and to a profit sharing method of sharing some proportion of a profit acquired by selling the article developed to the consumers. The present disclosure relates to subject matter contained in Japanese Patent application No. 2001-57986 (filed on Mar. 2, 2001), which is expressly incorporated herein by reference in its entirety.

2. Description of the Related Art

A maker that produces a commercial article has hitherto collected favorites and opinions of the consumers by sending questionnaires to the consumers on the occasion of developing the article. When the consumers answer the questionnaires, the maker collects the answers to the questionnaires, and develops the article taking the result of the collection into consideration.

The maker, however, simply refers to the result of the collection of the answers to the questionnaires as reference data for developing the article, and does not directly utilize the result thereof. Hence, the consumers answering the questionnaires are unable to clearly know how the result of the collection thereof was utilized for developing the article.

Further, the maker, even when trying to return a part of the profit to the consumers (participants) having answered the questionnaires, is incapable of returning the profit based on an impartial standard to the participants, because the participants′ acts of answering the questionnaires do not directly contribute to the development of the article.

### SUMMARY OF THE INVENTION

Accordingly, it is a primary object of the present invention to provide a commercial article developing method of prompting consumers to participate in developing a commercial article. It is another object of the present invention to provide a profit sharing method of sharing some proportion of a profit among consumers (participants) who have contributed to the development of the commercial article.

To accomplish the above objects, according to one aspect of the present invention, a profit sharing method executed by a server computer, comprises following steps.

Namely, the program comprises a step of obtaining pieces of answer information each specifying an option selected by a participant from options corresponding to an element which characterizes a commercial article; a step of specifying one option as an adopted option corresponding to the element, based on the pieces of answer information obtained in said obtaining step; a step of assigning predetermined points to a participant who selected the option equivalent to said adopted option; and a step of determining individual return value which should be given to the participant in accordance with the points assigned to the participant.

With this architecture, the server computer collects the answer information obtained and is thereby capable of ranking the options selected by the participants with respect to each element on the basis of a standard of how many participants selected the option. Then, an adopted option to be adopted for the actual article is determined from some high-ranking options selected by the majority of participants. It is therefore expected the article developed based on the adopted option meets tastes and favorites of the majority of participants . Note that the option that ranks first among the respective options may be automatically specified as the adopted option. Further, a person in charge of this task in the maker may specify the adopted option from the high-rankings of those options.

Moreover, the participant is given the portion of the profit. The portion is determined based on the points assigned to the participant. For example, if the option selected by the participant becomes the adopted option, the points as a weight value preset for the element corresponding to the adopted option, are given thereto. Then, the participant is given the profit return corresponding to the individual points defined as a total of the points given.

### BRIEF DESCRIPTION OF THE DRAWINGS

The invention will be described below in detail with reference to the accompanying drawings, in which:

FIG. 1 is a diagram showing a system architecture in one embodiment of the present invention;

FIG. 2 is a schematic diagram showing a questionnaire table;

FIG. 3 is a schematic diagram showing a participant table;

FIG. 4 is a flowchart showing a questionnaire process;

FIG. 5 is a schematic diagram showing one example of a questionnaire screen;

FIG. 6 is a schematic diagram showing one example of an answer file;

FIG. 7 is a flowchart showing a commercial article developing process;

FIG. 8 is a schematic diagram showing a collection table;

FIG. 9 is a schematic diagram showing an adoption table;

FIG. 10 is a schematic diagram showing a display example of an article commercializing image;

FIG. 11 is a flowchart showing a process of disclosing a sales achievement; and

FIG. 12 is a flowchart showing a profit sharing process.

### DESCRIPTION OF THE PREFERRED EMBODIMENT

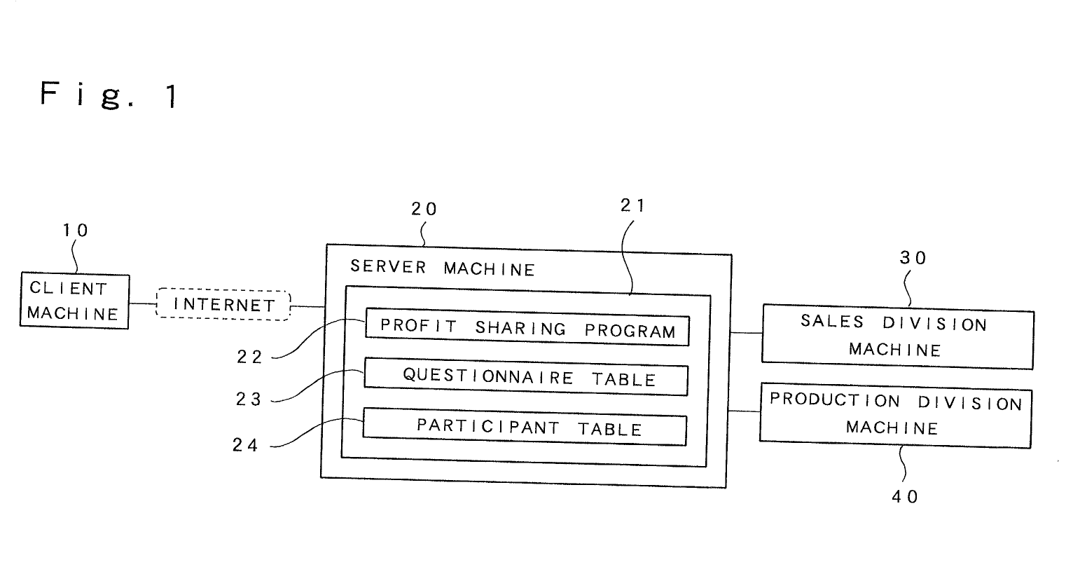

One embodiment of the present invention will hereinafter be described with reference to the accompanying drawings. FIG. 1 is a diagram showing a system architecture in this embodiment. This system comprises a client machine 10 of a consumer (participant), a server machine 20 managed by a maker, a sales division machine 30 for processing in a sales division of the maker, and a production division machine 40 for processing in a production division of the maker.

The client machine 10 may be defined as a personal computer into which a WWW (World Wide Web) browser program has been installed. This client machine 10 is connectable via the Internet to the server machine 20.

The server machine 20 is constructed of a high-function computer and is connected to the sales division machine 30 and the production division machine 40, respectively. This server machine 20 incorporates a hard disk (HDD) 21. A profit sharing program 22 has been installed into this HDD 21. This profit sharing program 22 comprises a plurality of modules, and functions as a WWW server program.

Then, the maker, on the occasion of developing a new commercial article, sends questionnaires about this new article to the consumers through the server machine 20, and designs the article based on answers to the questionnaires. To be specific, the maker lists up elements characterizing the article to be developed, and prepares options for every element.

If the article for development is, for example, jeans, the maker lists up the elements such as a color of the jeans, a shape of the jeans, a color and a pattern of pockets, metal fittings, a shape of a belt hole and so on. Further, the maker prepares options for every element. Namely, a plurality of jeans cloth colors different from each other are prepared as options for the element [color of jeans].

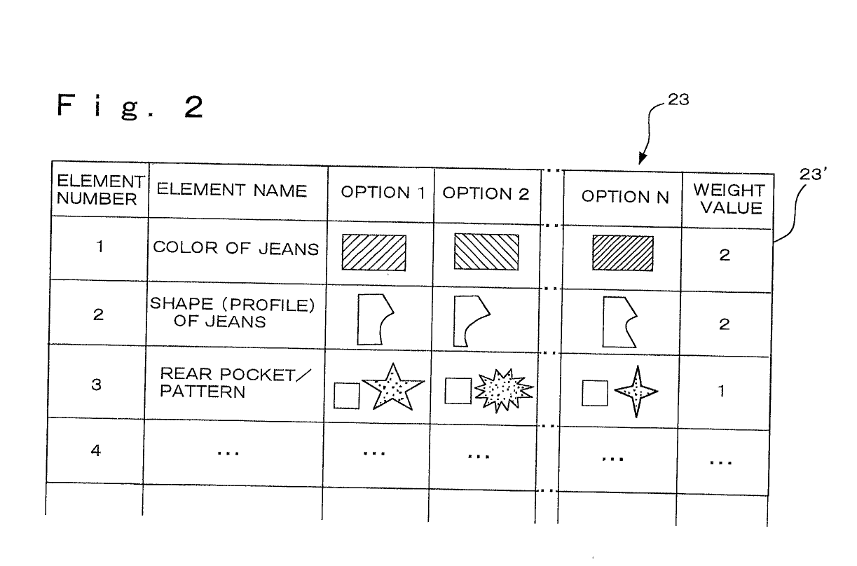

Then, the maker sorts pieces of information on the respective elements and options corresponding to these elements as a questionnaire table 23. This questionnaire table 23 is stored in the HDD 21 of the server machine 20. FIG. 2 is a schematic diagram of this questionnaire table 23. This questionnaire table 23 contains records (each forming a set of questionnaire data 23′) corresponding to the respective elements.

Each record of the questionnaire data 23′ includes of an “element number” field stored with an element number unique to each element, an “element name” field stored with a name of each element, “option” fields stored with pieces of image data as options (1-N), and a “weight value” field. This “weight value” field is stored with a weight value, which represents importance of the element corresponding to the questionnaire data 23′ to characterize the article.

As shown in FIG. 2, in the record of the questionnaire data 23′ given “1” as the “element number”, the “element name” is the “color of jeans”, and the respective “option” fields are stored with the image data of the jeans cloths as the options. Note that these pieces of image data are, as a matter of fact, color image data.

In the record of the questionnaire data 23′ given “2” as the “element number”, the “element name” is the “shape (profile) of jeans”, and the respective “option” fields are stored with the image data when the jeans are viewed sideways.

In the record of the questionnaire data 23′ given “3” as the “element number”, the “element name” is the “rear pocket/pattern”, and the respective “option” fields are stored with the image data showing shapes and patterns of the rear pocket. Note that one set of questionnaire data 23′ is created corresponding to the shapes and the patterns of the rear pocket in the example shown in FIG. 2, however, one set of questionnaire data 23′ corresponding to the shapes of the rear pocket and another set of questionnaire data 23′ corresponding to the patterns of the rear pocket, may also be individually created.

Further, in two sets of the questionnaire data 23′ given the “element numbers” of “1” and “2”, both of the “weight values” thereof are “2”. On the other hand, in the questionnaire data 23′ given “3” as the “element number”, its “weight value” is “1”. The weight value is set larger as the degree of importance of characterizing the article becomes higher. For instance, the element “color of jeans” and the element “shape (profile) jeans” have the higher degree of importance in terms of characterizing the article than that of the element “rear pocket/pattern”. Namely, the high weight values are given to the elements “color of jeans” and “shape (profile) of jeans”, which determine an impression of the article as a whole. By contrast, the low weight value is given to the element “rear pocket/pattern” related to a partial impression of the article.

Note that FIG. 2 shows only one questionnaire table 23, however, questionnaire tables 23 of a plurality of categories may also be created corresponding to ages and distinctions of sexes of the consumers. For example, the questionnaire table 23 oriented to the females in their 20's and the questionnaire table 23 oriented to the males in their 10's are, though the items of the respective elements (element names) are the same, different in their options corresponding to the elements.

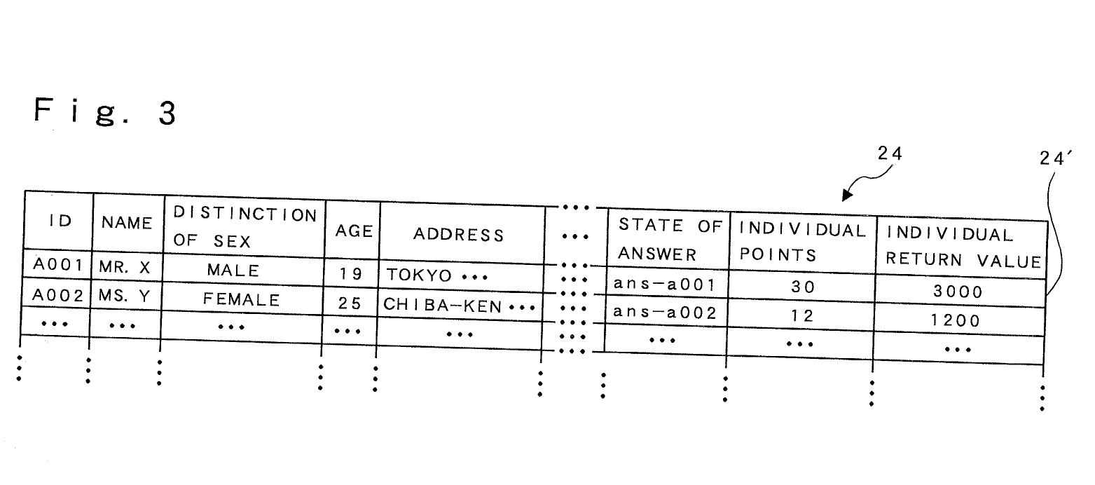

Further, as shown in FIG. 1, the HDD 21 of the server machine 20 is stored with a participant table 24. FIG. 3 is a diagram schematically showing the participant table 24. This participant table 24 contains records (each forming a set of participant data 24′).

Each record of the participant data 24′ includes an “ID” field stored with a participant ID unique to a participant, a “name” field stored with a name of the participant, a “distinction of sex” field stored with a sex of the participant, an “age” field stored with an age of the participant, an “address” field stored with an address of the participant, a “state of answer” field, an “individual point” field, and an “individual return value” field.

Note that when the participants answer the questionnaire, contents of the answers are stored in the HDD 21 as an answer file R (see FIG. 6) which will be mentioned later on. The “state of answer” field in FIG. 3 is stored with a file name of the answer file R. For instance, in the participant data 24′ given “A001” as the participant “ID”, the “state of answer” field is stored with “ans-a001”. Namely, the file name of the answer file R of this participant is “ans-a001”. Note that if the participant does not yet answer the questionnaire, the “state of answer” field in the participant data 24′ corresponding to this participant is blank.

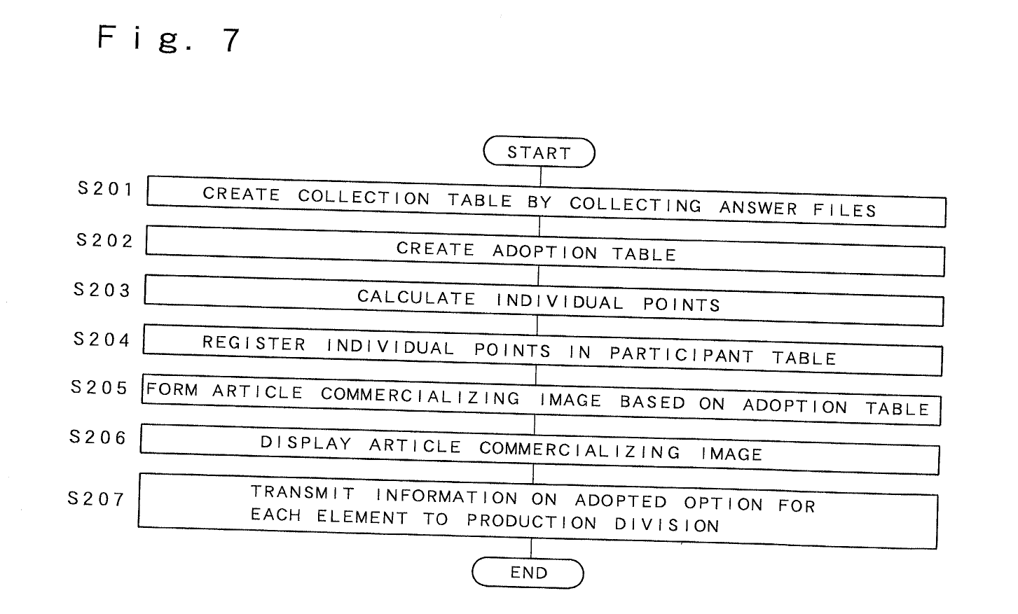

The “individual point” field is stored with a value of individual points given to the participant in accordance with the answer of the participant. The “individual return value” field is stored with an individual return value equivalent to, e.g., an amount of money shared to the participant based on the individual points. It should be noted that discussions on the calculation of the individual points and the individual return value will hereinafter be made respectively referring to FIGS. 7 and 12.

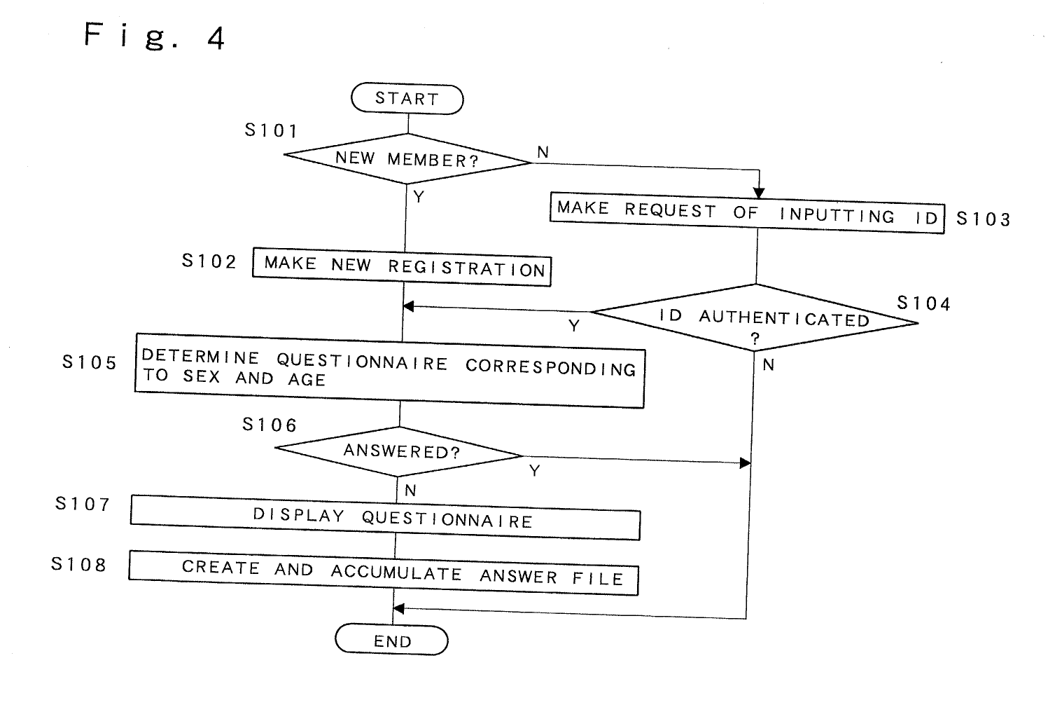

FIG. 4 is a flowchart showing a questionnaire process executed by the server machine 20. The questionnaire process in this flowchart in FIG. 4 starts with the participant notifying the server machine 20 of an intention of answering the questionnaire by operating the client machine 10 to execute the browser program for establishing a connection to the server machine 20.

In first step S101, the server machine 20 displays on the monitor of the client machine 10 a screen for inquiring about whether or not the participant operating this client machine 10 is a new member. Then, the server machine 20, if this participant is judged to be the new member, advances the processing to S102, whereas if not the new member, the server machine 20 moves the processing forwards to S103. Note that this server machine 20 provides services in a variety of categories, and the general consumers are able to utilize these services by registering their memberships. Then, upon registering the membership, the server machine 20 creates the participant data 24′. Accordingly, if the participant has ever utilized before some of those services provided by the server machine 20, the participant data 24′ of this participant was stored in the HDD 21 of the server 20.

In S102, the server machine 20 displays an input screen on the monitor of the client machine 10 and prompts the participant to input his or her name, sex, age and address. Then, the server machine 20 creates one record of new participant data 24′. The “ID” field in this record of participant data 24′ is stored with a new ID. Other fields such as “name”, “distinction of sex”, “age” and “address” in the participant data 24′ are stored with items of information inputted by the participant. These pieces of participant data 24′ are called [processing target participant data 24′] in the following process. Then, the processing proceeds to S105.

On the other hand, in S103, the server machine 20 displays an ID input screen on the monitor of the client machine 10, and prompts the participant to input the participant's ID.

In S104, the server machine 20 searches a set of participant data 24′ corresponding to the participant ID inputted by the participant in S103. If the search hits this set of participant data 24′, the processing proceeds to S105. Note that the thus specified participant data 24′ is called the [processing target participant data 24′] in the following process. On the other hand, if the search does not hit the participant data 24′, the server machine 20 finishes the processing.

In S105, the server machine 20 refers to the “distinction of sex” field and “age” field in the processing target participant data 24′, and determines the questionnaire table 23 suited to the age and sex of this participant.

In S106, the server machine 20 checks whether or not the “state of answer” field in the processing target participant data 24′ is blank. Then, the server machine 20, if the “state of answer” field is not blank, judges that this participant has already answered the questionnaire, and finishes the processing. While on the other hand, the server machine 20, if the “state of answer” field is blank, judges that this participant does not yet answer, and advances the processing to S107.

In S107, the server machine 20 displays on the monitor of the client machine 10 a questionnaire screen (showing pieces of information for selection) corresponding to each set of questionnaire data 23′ in the questionnaire table 23 determined in S105, and prompts the participant to input answers corresponding to the fields in the questionnaire data 23′.

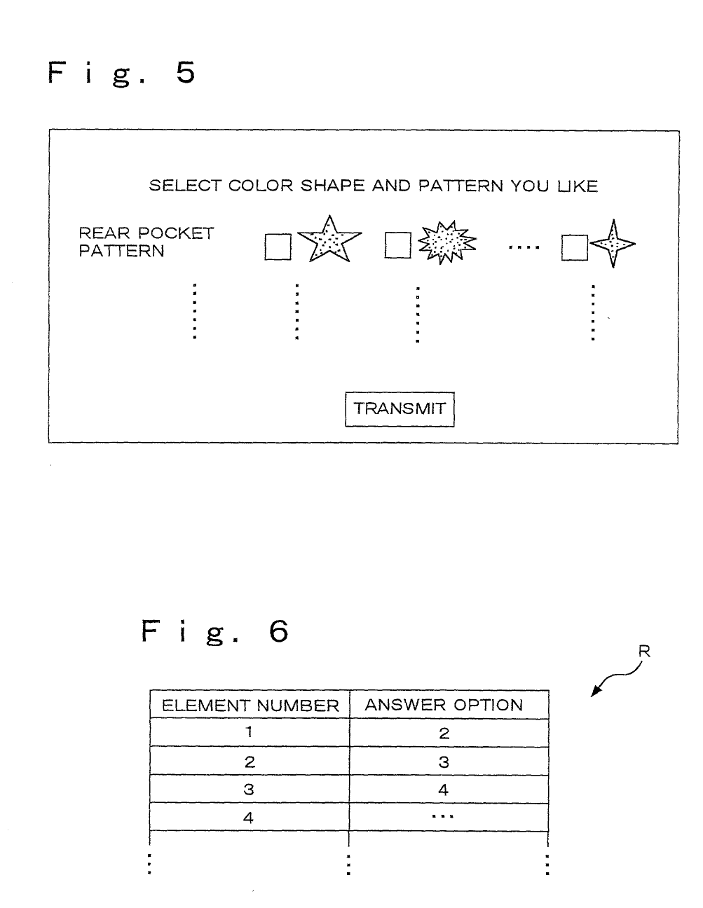

FIG. 5 is a schematic diagram showing one example of the questionnaire screen. This questionnaire screen contains pieces of image data corresponding respectively to the “option” fields in the questionnaire data 23′. For example, in the questionnaire data 23′ given the “element number” of “3” in the questionnaire table 23 shown in FIG. 2, the element name is the “rear packet/pattern”, and pieces of image data corresponding to the “option” fields are displayed on the questionnaire screen in FIG. 5. Then, the participant selects the favorite options by one to fill the respective “option” fields of the questionnaire data 23′. Thereafter, the client machine 10 transmits pieces of information for specifying the options selected by the participant as answer information to the server machine 20.

In S108, the server machine 20 obtains the answer information transmitted from the client machine 10 in S107. Based on the answer information, the server machine 20 creates an answer file indicating the options selected by the participant, and stores the answer file in the HDD 21. Note that an answer file for a participant is created with respect to the questionnaire table determined in S105.

FIG. 6 is a schematic diagram showing the answer file R. This answer file R includes an “element number” field and an “answer option” field. The “answer option” field, each corresponding to the “element number”, is stored with an option number selected by the participant. Note that the file name of the answer file R is stored in the “state of answer” field in the participant data 24′ (FIG. 3). Then, the server machine 20 finishes the processing.

It should be noted that the questionnaire about the jeans is exemplified in the embodiment discussed above, however, questionnaires about jackets and other articles may also be prepared. In this case, questionnaire tables of other articles with respect to sex and age, should be prepared. Further, the “state of answer” field, the “individual point” field and the “individual return value” field should be added corresponding to other articles to the above participant table 24.

An article development process based on the results of answers to the questionnaire will hereinafter be explained referring to a flowchart in FIG. 7. The article development process in the flowchart in FIG. 7 is executed by the server machine 20 after accumulation of a predetermined number of the answer files R created by the process in FIG. 4. The article development process in the flowchart in FIG. 7 is executed individually for each article developed corresponding to each age and sex.

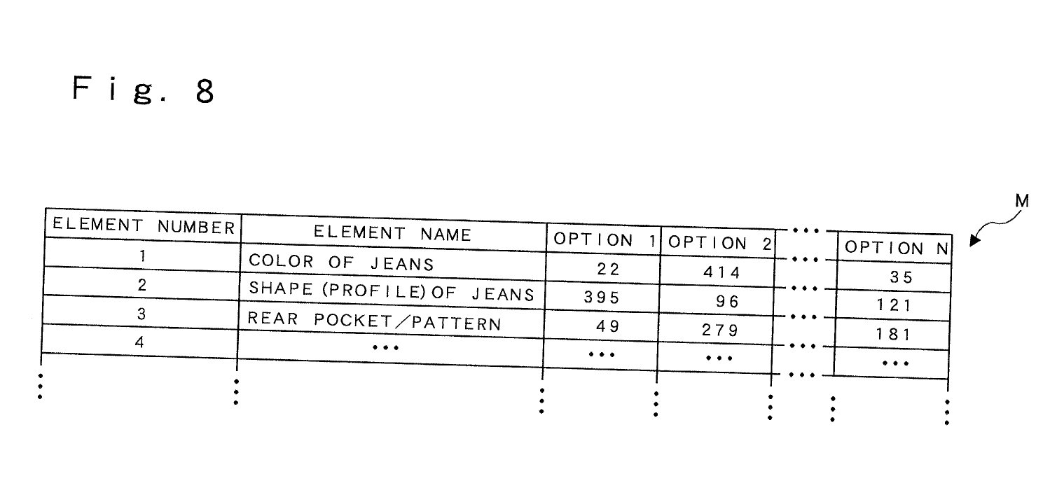

In first step S201, the server machine 20 collects the answer files R accumulated, and creates a collection table M shown in FIG. 8. The server machine 20, however, collects only the answer files R of the participants who meet the conditions of the ages and the sex corresponding to the processing target article. As shown in FIG. 8, the collection table M includes an “element number” field, an “element name” field and “option” fields. The “option” fields, corresponding to the “element number”, are stored with the number of participants having selected respective options.

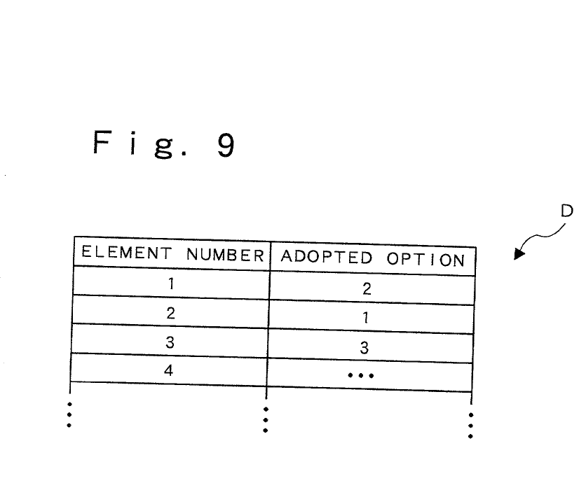

In next step S202, the server machine 20, based on the collection table M created in S201, specifies per element which option is selected most. To be specific, the server machine 20 refers to the collection table M (FIG. 8) and determines the “option” field stored with the maximum value among the “option” fields corresponding to each “element number”, as an adopted option corresponding to the element concerned, thus creating an adoption table D shown in FIG. 9. This adoption table D includes an “element number” field and an “adopted option” field. The “adopted option” field is stored with the option number selected most. FIG. 9 shows that the option number “2” is selected by the maximum number of participants with respect to, for instance, the element given “1” as the “element number”.

Note that the option selected most is automatically determined as the adopted option in the embodiment discussed above. The determination mode is not limited to this, and a person in charge of the determination in the maker may also determine the adopted option among a plurality of options selected by a comparatively larger number of participants.

In next step S203, the server machine 20 calculates the individual points corresponding to each participant. More specifically, the server machine 20 compares the “answer option” in the answer file R of the participant with the “adopted option” in the adoption table D with respect to each “element number”, and, if the “answer option” is coincident with the “adopted option”, gives points to the participant concerned. Note that as shown in FIG. 2 the “weight value” has been set in each set of questionnaire data 23′. If the “answer option” is coincident with the “adopted option” with respect to a certain “element number”, the “weight value” in the questionnaire data 23′ corresponding to this “element number” is given as points to the participant. Then, with respect to each “element number”, the server machine 20 calculates a sum of the points given to the participant as individual points of the participant concerned. Note that the individual point of the participant given no point is “0”.

In next step S204, the server machine 20 stores the individual points calculated in S203 in the “individual point” field of the participant data 24′ in the participant table 24 (see FIG. 3).

In S205, the server machine 20 forms an article commercializing image based on the adoption table D(FIG. 9) created in S202. Namely, the server machine 20 specifies each option (the adopted option) corresponding to each element on the basis of the adoption table D, and forms the article commercializing image defined as image data of the article configured by pieces of image data of the respective option specified.

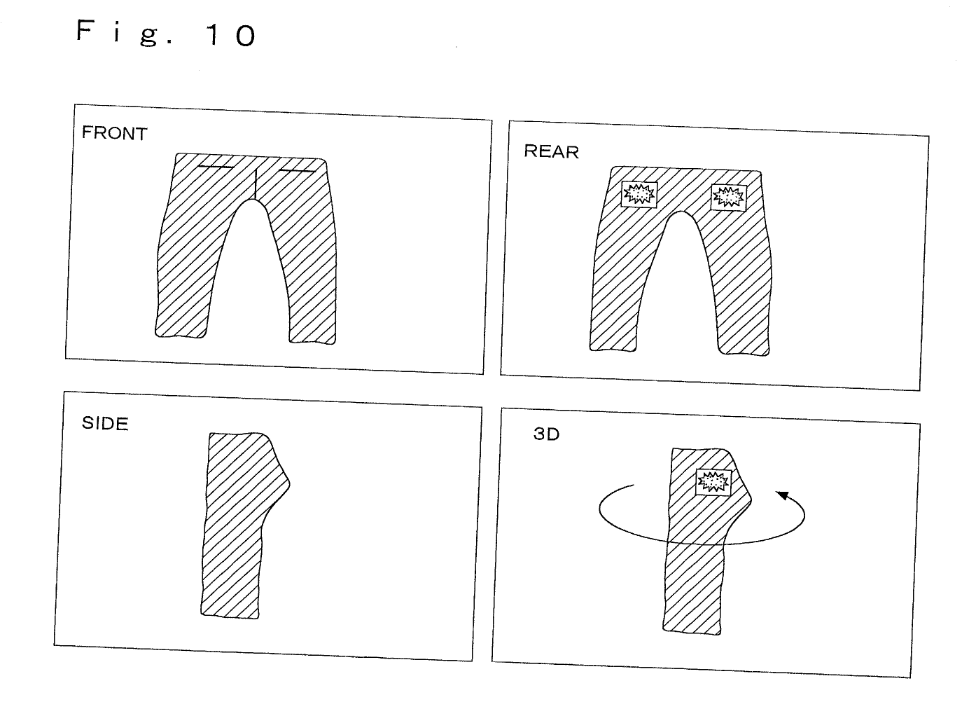

In S206, the server machine 20 creates Web data containing the article commercializing data formed in S205. Then, the participants operating the client machines 10 and persons in charge of operating the sales division machine 30 and the production division machine 40, are able to display the article commercializing image on the screens thereof. FIG. 10 is a schematic diagram showing a display example of this article commercializing image. As illustrated in FIG. 10, the front, the side and the rear images of the article may also be respectively displayed on the screen. Further, a three dimensional (3D) image of the article may also be displayed on the screen. In the case of this 3D display, it is desirable that a position and a direction of the article displayed within the screen can be changed interactively.

In S207, the server machine 20 transmits pieces of information indicating the adopted options shown in the adoption table D to the production division machine 40, and finishes the processing. Then, the person in charge of the production division starts producing the new article on the basis of the information transmitted to the production division machine 40. Note that pieces of information on shapes and standards pertaining the adopted options together with the information indicating the adopted options, may be transmitted to the production division machine 40.

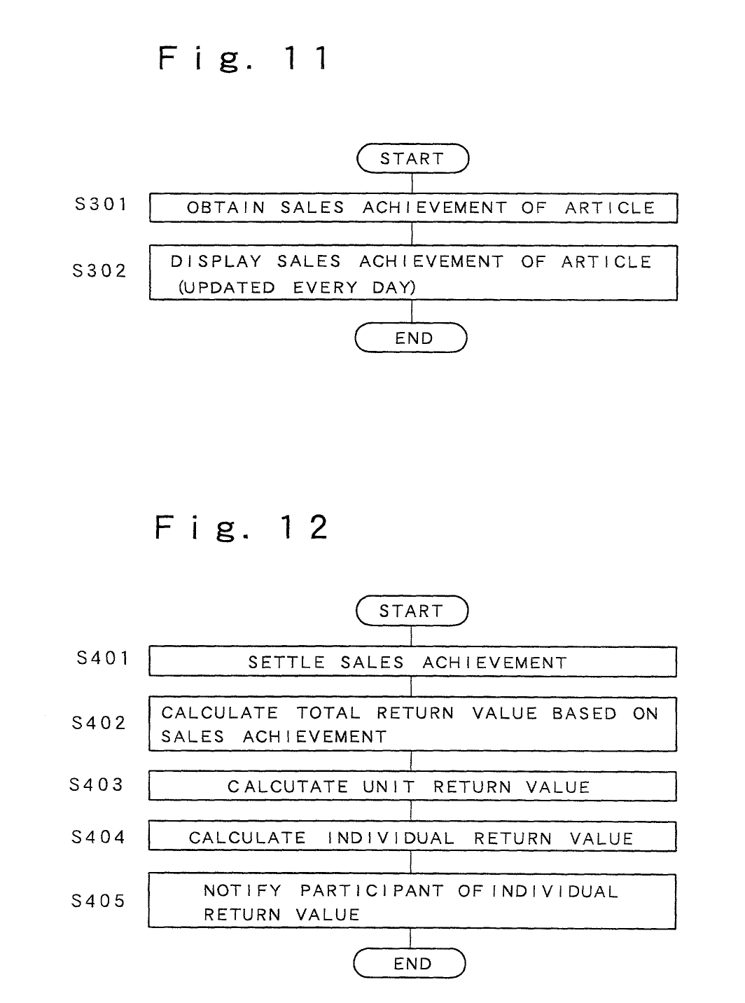

The sales division sells the new article produced by the production division. The sales division machine 30 collects a sales achievement such as a numerical quantity of the articles sold by the sales division, proceeds, and a profit. Then, thus collected sales achievement is disclosed to the participants. A process of disclosing the sales achievement of the article will be explained with reference to a flowchart in FIG. 11. The server machine 20 starts the disclosing process in FIG. 11, for instance, once a day at a predetermined time.

In S301, the server machine 20 obtains the sales achievement collected by the sales division machine 30. This sales achievement may contain the numerical quantity of the sales, proceeds, and the profit.

In S302, the server machine 20 creates Web data containing the sales achievement obtained in S301, and finishes the processing. The participants are able to display the Web data containing the sales achievement on the screen of the monitor of the client machine 10. Accordingly, the participants are able to know the latest sales achievement of the article developed based on the participation of the participants themselves.

A process of sharing some proportion of the profit acquired by selling the article among the participants, will be described with reference to a flowchart in FIG. 12. The profit sharing process in the flowchart shown in FIG. 12 is executed on a predetermined date set by the maker concerning the settlement day etc. Note that the profit sharing process is individually executed for every article developed corresponding to each age and sex.

In first step S401, the server machine 20 settles the sales achievement. For example, the server machine 20 calculates a profit after the start of selling the article.

In S402, the server machine 20, based on the sales achievement settled in S401, calculates a total return value equivalent to a total sum of amounts of money that should be shared among the participants. For instance, the server machine 20 calculates 5% of the profits calculated in S401 as a total return value.

In S403, the server machine 20 calculates a unit return value. Specifically, to begin with, the server machine 20 adds all the “individual points” of the participants conforming with the age and sex at which the article targets, thus calculating total points as a total sum of the individual points. Namely, the server 20 extracts all sets of participant data 24′ whose “age” field and “distinction of sex” field are stored with the information coincident with the age and the sex at which the article concerned targets. Then, the server machine 20 adds all the “individual points” of the extracted sets of participant data 24′, thus calculating the total points related to the article concerned. Further, the server machine 20 divides the total return value calculated in S402 by the total points to calculate a unit return value.

In S404, the server machine 20 multiplies the “individual points” in each set of participant data 24′ (FIG. 3) by the unit return value calculated in S403, thereby calculating an individual return value equivalent to an amount of money that w should be given to the participant concerned. Then, the server machine 20 stores the thus calculated individual return value in the “individual return value” field in the corresponding set of participant data 24′.

In S405, the server machine 20 notifies each of the corresponding participants of the individual return value calculated in S404, and finishes the processing. For example, the server machine 20 creates the Web data accessible by only each of the participants, and sets the individual return value possible of being browsed by only the corresponding participant. Further, the server machine 20 may notify the corresponding participant of the individual return value by an email.

The participant notified of the individual return value is able to enjoy a service equivalent to the individual return value acquired. For instance, the participant may utilize this individual return value for shopping in a shopping mall opened on the Web, or may receive a gift certificate and a prepaid card equivalent to this individual return value. Further, this individual return value may also be changeable into money.

As discussed above, according to the profit sharing method in this embodiment, the maker can develop the commercial articles meeting the favorites of the consumers in a short period of time. Further, the profit is shared fairly and impartially among the participants who answered the questionnaire in accordance with the degree of the contribution to the development of the article, and hence it follows that more consumers as the participants take part in developing the articles. The present invention is not limited to the architecture described above. For example, the client machine 10 may be a mobile telephone incorporating a function of transmitting and receiving image information and character information, and the client machine 10 and the server machine 20 may be connected to each other via a wire or wireless communication network other than the Internet.

According to the profit sharing method and the profit sharing program of the present invention that have the architectures described above, the consumers are able to take part as the participants in the developments of the articles and therefore have much higher concerns about the articles. Moreover, a portion of the profit calculated based on the degree of the contribution to the development of the article is given fairly to the participant, and it therefore follows that more participants take part in developing the articles.

What is claimed is:

1. A profit sharing method executed by a server computer, comprising:
a step of obtaining pieces of answer information each specifying an option selected by a participant from options corresponding to an element which characterizes a commercial article;
a step of specifying one option as an adopted option corresponding to the element, based on the pieces of answer information obtained in said obtaining step;
a step of assigning predetermined points to a participant who selected the option equivalent to said adopted option; and
a step of determining an individual return value which should be given to the participant in accordance with the points assigned to the participant.

2. The method according to claim 1, wherein
one of the options selected by most participants is specified as the adopted option in said specifying step.

3. The method according to claim 1, wherein
each piece of answer information specifies, as to a plurality of elements, options which characterize the commercial article, respectively.

4. The method according to claim 1, wherein
said determining step determines the individual return value by multiplying points assigned to the participant by a unit return value calculated by dividing a total return value equivalent to an amount of money should be returned to the participants by a total of the points assigned to respective participants.

5. The method according to claim 1, further comprising a step of transmitting a piece of selection information indicating the options corresponding to the element to a client computer of the participant that is connected to said server computer.

6. The method according to claim 1, further comprising a step of creating image data of the article characterized by the adopted option.

7. A profit sharing method executed by a client computer connectable to a server computer, comprising:
a step of obtaining pieces of answer information each specifying at least an option selected by a participant from options corresponding to an element which characterizes a commercial article; and
a step of sending the answer information obtained in said obtaining step to the server computer for making said server computer execute:
a step of specifying one option as an adopted option corresponding to the element, based on the pieces of answer information obtained in said obtaining step,
a step of assigning predetermined points to a participant who selected the option equivalent to said adopted option, and
a step of determining individual return values should be respectively given to participants in accordance with the point assigned to the participants.

8. A computer readable medium containing a profit sharing program comprising:
a module making a server computer execute a step of obtaining pieces of answer information each specifying at least an option selected by a participant from options corresponding to an element which characterizes a commercial article;
a module making the server computer execute a step of specifying one option as an adopted option corresponding to the element, based on the pieces of answer information obtained in said obtaining step;
a module making the server computer execute a step of assigning predetermined points to a participant who selected the option equivalent to said adopted option; and
a module making the server computer execute a step of determining individual return values should be respectively given to participants in accordance with the points assigned to the participants.

9. A program product comprising:
a module making a server computer execute a step of obtaining pieces of answer information each specifying at least an option selected by a participant from options corresponding to an element which characterizes a commercial article;
a module making the server computer execute a step of specifying one option as an adopted option corresponding to the element, based on the pieces of answer information obtained in said obtaining step;
a module making the server computer execute a step of assigning predetermined points to a participant who selected the option equivalent to said adopted option; and
a module making the server computer execute a step of determining individual return values should be respectively given to participants in accordance with the points assigned to the participants.

10. A profit sharing system comprising:
a server computer connectable to a client computer; and
a storing device containing a profit sharing program comprising:
a module making the server computer execute a step of obtaining pieces of answer information each specifying at least an option selected by a participant from options corresponding to an element which characterizes a commercial article,
a module making the server computer execute a step of specifying one option as an adopted option corresponding to the element, based on the pieces of answer information obtained in said obtaining step,
a module making the server computer execute a step of assigning predetermined points to a participant who selected the option equivalent to said adopted option, and
a module making the server computer execute a step of determining individual return values should be respectively given to participants in accordance with the points assigned to the participants.

11. A commercial article developing method comprising:
a step of obtaining pieces of answer information each specifying at least an option selected by a participant from options corresponding to an element which characterizes a commercial article;
a step of specifying one option as an adopted option corresponding to the element, based on the pieces of answer information obtained in said obtaining step; and
a step of developing a commercial article on the basis of the adopted option specified in said specifying step.
